(19) United States
(12) Patent Application Publication
(10) Pub. No.: US 2008/0076402 A1
(43) Pub. Date: Mar. 27, 2008

(54) Method and Apparatus for Requesting Service Using Access Code

(76) Inventor: Yong-Seok Jeong, Gwangjoo (KR)

Correspondence Address: IPLA P.A., 3580 WILSHIRE BLVD., 17TH FLOOR, LOS ANGELES, CA, 90010, US

(21) Appl. No.: 11/718,321

(22) PCT Filed: Nov. 2, 2005
(86) PCT No.: PCT/KR05/03668

§ 371 Date: Apr. 30, 2007

(30) Foreign Application Priority Data
Nov. 2, 2004 (KR) 10-2004-0088227
Nov. 20, 2004 (KR) 10-2004-0095492
Jun. 24, 2005 (KR) 10-2005-0054790

(51) Int. Cl. H04Q 7/20

(52) U.S. Cl. 455/422.1

(57) ABSTRACT

A method and apparatus for requesting service using access codes are disclosed. According to a preferred embodiment of the present invention, a user terminal receives and displays detailed information corresponding to a data or an advertisement displayed on or played over information media, or performs ordering/payment for a product corresponding to the advertisement, according to the inputted access code. The invention uses access codes assigned to data or advertisements corresponding to information media to provide convenience in requesting detailed information on the data or advertisement and in ordering/payment for a product corresponding to the advertisement.

### TECHNICAL FIELD

The present invention relates to a method and apparatus for requesting service, more specifically to a method and apparatus for requesting service using access codes.

### BACKGROUND ART

Much information is being provided in various forms of information media. For example, various visual data is provided over visual media such as television (i.e. regular television, digital television, etc.), various sound data is provided over sound media such as radio, etc., and various visible data is provided over print media such as newspapers and magazines. In addition, self-advertisement terminals in department stores and fashion malls, as well as kiosks in stations, buildings, bookstores, and public facilities, etc. also provide various kinds of information.

The information provided by each of these information media may vary according to the purpose of each form of media.

For instance, a large number of products are currently merchandised through TV home shopping, product catalogues, Internet shopping malls, and the like. To purchase the products advertised in various forms of advertising media, consumers either call the numbers displayed with the advertising media or go through a series of procedures to connect to product purchase web pages and purchase the desired products. In this process, consumers specify the desired products by inputting 6-7 digit product codes marked on the products of interest while on the line with an operator or while proceeding through an automated order placement. Thus, the prior method of product ordering and payment is performed through several steps such as attempting a call, conversing with an operator, identifying the product, and making payment, etc., requiring a lot of time and resources.

Further, with air wave services, such as cable TV, music broadcasting, and radio broadcasting, which serve a general public, businesses are denied a means of effectively providing additional information due to limited broadcasting times and broadcasting characteristics. Information provided over print media also provides limited information due to the limited space, etc.

Even if the various services described above were provided in the form of bi-directional services, service exchange between each information media still remains a difficult problem. In other words, since the data provided via information media (i.e. visual media, print media, and sound media, etc.) or the product advertised cannot be provided in connection with the related detailed information, the consumer must use a separate communication terminal to access the detailed information related to the data or product of interest. Also, the connection address required to access the detailed information must be inputted manually by the consumer. Although barcodes and two-dimensional barcodes have been proposed to alleviate the inconvenience of manual input, they have not been popularized.

### DISCLOSURE

### Technical Problem

In order to solve the aforementioned problems, the present invention aims to provide a method and apparatus for requesting service using access codes, which allow easy access to detailed information on a data or an advertisement and/or easy ordering and payment for a product corresponding to the advertisement of interest using access codes assigned to the data or advertisement corresponding to the information media (e.g. visual media, print media, and sound media).

Another objective of this invention is to provide a method and apparatus for requesting service using access codes, in cases where the display of access codes may be difficult such as in visual media or sound media, wherein pre-designated access codes (e.g. channel data, broadcasting station data, etc.) or frequencies are identified as the access codes corresponding to particular data or advertisements to provide the related services.

A further objective of the invention is to provide a method and apparatus for requesting service using access codes, with which services using access codes can be provided regardless of the type or capabilities of the user terminals.

Still another objective of the invention is to provide a method and apparatus for requesting service using access codes, with which the data supplied over visual media or sound media or detailed information and/or ordering with regard to an advertisement may also be provided in a non-real-time manner. Thus, the consumer is allowed to make a careful decision when ordering a product, to consequently discourage impulse buying.

Yet another objective of the invention is to provide a method and apparatus for requesting service using access codes, with which optimal service may be provided without language limitations even for a broadcast or website with a worldwide audience.

Another objective of the invention is to provide a method and apparatus for requesting service using access codes, with which decision element data (e.g. data generated using the access code and time data, etc.) generated by a first user can be transmitted to a second user, so that the second user may access the same service.

A further objective of the invention is to provide a method and apparatus for requesting service using access codes, with which a user may make a payment for a product order using a communication terminal.

The present invention also aims to provide a method and apparatus for requesting service using access codes, which allow payment for a product or service (e.g. gas, food, etc.) even at an off-line store (e.g. gas station, restaurant, etc.) using a reserved word.

Yet another objective of the invention is to provide a method and apparatus for requesting service using access codes, which allow accurate ordering of a product by automatically correcting a discrepancy occurred between the time the data is received and the time the data is displayed, which may exist even in satellite broadcasting or in the same broadcasting medium.

### Technical Solution

To achieve the foregoing objectives, one aspect of the invention provides a method for requesting service using access codes and/or a recorded medium embodying a program to perform the method.

In a preferred embodiment, a method of requesting service using a user terminal related to transferred data corresponding to at least one of a data and an advertisement provided over information media is provided, comprising: (a) receiving an access code corresponding to the transferred data as input, (b) generating a request data corresponding to at least one of an order request and a detailed information request using the access code and a corresponding time data when a transmission request for the request data is inputted, and transmitting the generated request data to a service apparatus including at least one of an information device and a product management device, and (c) displaying information corresponding to data or connection address data received from the service apparatus, wherein the information media is at least one of visual media, print media, and sound media, and the time data is configured to be the time before or after the input of the access code.

The method for requesting service using access codes may further comprise storing the access code and the time data, displaying one or more access codes in response to a display stored data command, and receiving as input a select command for the access code, and a generate and transmit command for the request data before generating a request data (step b).

The access code and the time data may be stored as electronic files in a pre-configured file format when storing the access code and the time data. Also, the electronic file may be generated to comprise one or more additional data corresponding to a pre-configured or user-specified resource storage structure, where the additional data may include one or more of location data, personal data, payment data, access data of the user terminal, hobby data, gender data, e-mail address, and assigned service number data.

The service apparatus may extract, from a pre-stored mapping table, data corresponding to the access code and the time data or connection address data and may transmit the data to the user terminal.

The time data may be revised time data, in which the original time data configured to be the time before or after the input of the access code is compensated by a predetermined discrepancy value.

In generating a request data (step b), the request data may be generated using the location data, the access code, and the time data, after recognizing the location data of the user terminal.

The method for requesting service using access codes may further comprise receiving a payment data request corresponding to the order request from the service apparatus, and transmitting payment data to the information device via a communication network in correspondence to the payment data request.

The access code may be data corresponding to any one of a frequency, by which the transferred data is outputted, and a telephone number corresponding to the transferred data, when the information media is sound media.

The method for requesting service using access codes may further comprise pre-storing connection data corresponding respectively to one or more access codes, determining whether or not the inputted access code matches the stored access code, and proceeding to generating a request data (step b) if the inputted access code does not match the stored access code.

Also, the method may further comprise extracting connection data corresponding to the access code if the inputted access code matches the stored access code, and attempting a connection via a communication network using the extracted connection data.

The access code may be formed of any one of a number sequence, a letter sequence, and an alphanumeric combination. For instance, the access code may be data formed of a number sequence, a letter sequence, or a combination of both regarding the domain.

The access code may comprise at least one of a media ID, a content ID, a serial number, and a product ID code. Also, the access code may further comprise at least one of a language ID code and a location ID code. When the access code comprises the location ID, the data displayed when displaying information (step c) may be location-based data corresponding to the location ID code. When the access code comprises the language ID, the data displayed when displaying information (step c) may be displayed in a language corresponding to the language ID code.

The data displayed when displaying information (step c) may be an option screen including a plurality of options corresponding to the request data. The option screen may include options corresponding to service categories corresponding to transferred data before or after the time data.

The time data may be inputted via an input unit, when the transferred data is video- or audio-recorded data.

The length of the access code may be variable depending on the characteristics of the information media, while the characteristics may include at least one of media type, issuance period, and frequency of usage.

In another preferred embodiment of the invention, a recorded medium readable by a digital processing device, tangibly embodying a program of instructions executable by the digital processing device to perform a method of requesting service using access codes is provided, comprising: receiving an access code corresponding to the transferred data as input, generating a request data corresponding to at least one of an order request and a detailed information request using the access code and a corresponding time data when a transmission request for request data is inputted, and transmitting the generated request data to a service apparatus including at least one of an information device and a product management device, and displaying information corresponding to data or connection address data received from the service apparatus, wherein the information media is at least one of visual media, print media, and sound media, and the time data is configured to be the time before or after the input of the access code.

To achieve the foregoing objectives, another aspect of the invention provides a user terminal by which to request service using access codes that may be identified from the information media.

In a preferred embodiment of the invention, a user terminal is provided by which to request service related to transferred data corresponding to at least one of a data and an advertisement provided over information media, comprising: an input unit, to which a command for transmitting access codes and request data is inputted, a storage unit, storing the access code and a corresponding time data, a request data generating unit, which generates request data corresponding to at least one of an order request and a detailed information request using the access code and the corresponding time data when the transmit command of the request data is inputted, a communication unit, which transmits the generated request data to a service apparatus including at least one of an information device and a product management device, and receives corresponding data or connection address data from the service apparatus, and a display unit, which displays data corresponding to the received data or the connection address data, wherein the information media is at least one of visual media, print media, and sound media, and the time data is configured to be the time before or after the input of the access code.

The storage unit may store electronic files generated to correspond to the access code and the time data, when the user terminal further comprises a file generating unit which generates electronic files in a pre-configured file format using the access code and the time data.

Also, the file generating unit may generate the electronic file to comprise one or more additional data corresponding to a pre-configured or user-specified resource storage structure, while the additional data may include one or more of location data, personal data, payment data, access data of the user terminal, hobby data, gender data, e-mail address, and assigned service number data.

The user terminal may further comprise a connection data extraction unit, which extracts the stored connection data in correspondence to the access code inputted through the input unit, when the storage unit pre-stores connection data corresponding to one or more access codes.

The communication unit may transmit the access data and a corresponding time data in correspondence to a receiver data, when a selection command for the access code and the receiver data are inputted through the input unit.

The user terminal may further comprise a time correction unit, which generates revised time data by compensating the original time data, which is configured to be the time before or after the input of the access code, by a predetermined discrepancy value.

The user terminal may further comprise a location data generating unit, which generates the location data of the user terminal, wherein the request data generating unit generates the request data using the generated location data, the access code, and the time data.

The user terminal may further comprise a payment data extraction unit, which extracts the payment data and provides it to the service apparatus via the communication unit, when the storage unit further stores payment data, and the communication unit receives a payment data request from the service apparatus corresponding to the order request.

When the information media is sound media, the access code may be data corresponding to any one of a frequency, by which the transferred data is outputted, and a telephone number corresponding to the transferred data.

The access code may be formed of any one of a number sequence, a letter sequence, and an alphanumeric combination comprising at least one of a media ID, a content ID, a serial number, and a product ID code. Also, the access code may further comprise at least one of a language ID code and a location ID code. When the access code comprises the location ID, the data displayed when displaying information (step c) may be location-based data corresponding to the location ID code. When the access code comprises the language ID, the data displayed when displaying information (step c) may be displayed in a language corresponding to the language ID code.

The data displayed via the display unit may be an option screen including a plurality of options corresponding to the request data.

The length of the access code may be variable depending on the characteristics of the information media, while the characteristics may include at least one of media type, issuance period, and frequency of usage.

### DESCRIPTION OF DRAWINGS

FIG. 1 shows an overview of a system for requesting service using access codes based on a preferred embodiment of the present invention.

FIGS. 2 to 4 illustrate forms of access codes based on a preferred embodiment of the invention.

FIG. 5 is a flowchart illustrating a method for requesting service using access codes based on a preferred embodiment of the invention.

FIG. 6 shows an example of a user interface (UI) screen illustrating the process by which access codes are inputted to request service, based on a preferred embodiment of the invention.

### LEGEND OF SYMBOLS FOR MAJOR COMPONENTS IN THE FIGURES

110 information media
120: user terminal
125: key input unit
130: decision element management unit
135 storage unit
140 display unit
145 request data generating unit
150 communication unit
155: control unit
160 information device
170: product management device

### Mode for Invention

The present invention, operative advantages of the present invention, and objectives achieved by embodying the present invention shall be apparent with regard to the accompanying drawings and the description therein.

Hereinafter, preferred embodiments of the present invention shall be described in detail with reference to the accompanying drawings.

The user terminal based on the present invention can receive an access code that can be recognized from information media as input and executes a request for data displayed on (e.g. in the case of visual media or print media) or outputted through (e.g. in the case of sound media) an information media or for detailed information on a corresponding advertisement, or executes a request for ordering/payment. Of course in some cases, the user terminal and the information media may be a single communication terminal. For instance, if the information media has a data channel, such as on a digital television, the user can input the access codes using the digital television itself, which consists the information media, for detailed information, and the ordering/payment of products.

Here, information media in the form of visual media or print media may display the access codes corresponding to particular data or advertisement together with the data. The access codes applied to visual media or print media may be formed of a number sequence (e.g. a number sequence based on a predetermined set of rules, the publication date of a print media, the product number of a book, magazine, or the like, the issue date or number of a newspaper, and the code issued to a leaflet, etc.), a letter sequence (e.g. the name of a newspaper reporter), or an alphanumeric combination (e.g. the issue date of a newspaper and the name of the reporter by whom an article was written, etc.), etc. For example, an access code may also be a domain data, telephone number, or name of the business formed of letters, numbers, or a combination of both. Also, in the case of sound media, a value (i.e. frequency value) corresponding to the radio frequency of the broadcasting station from which the data or advertisement of interest is outputted (for instance, 939 for FM radio 93.9 MHz) may be used as an access code.

In addition, the detailed information which may be provided to the user using an access code include for example in-depth information, related information, analysis information, and price comparison information on the data or advertisement of interest.

Also, the information media to which the present invention may be applied includes visual media such as television (i.e. regular television, digital television, etc.), sound media such as radio, and print media such as newspapers or magazines, etc. The visual media and sound media may further include self-advertisement terminals in department stores and fashion malls, as well as kiosks in stations, buildings, book stores, and public facilities, etc.

Different access codes may be applied to each case wherein a user requests detailed information and performs ordering/payment for a data or advertisement. For instance, the access codes may be applied with just the serial numbers differing.

Hereinafter, the description will relate to a case wherein the data provided over an information media is an advertisement, focusing on providing detailed information or ordering/payment corresponding to the advertisement. Through the descriptions below, anyone skilled in the art shall easily understand that an identical or similar process is used for the case of providing detailed information on a data over an information media.

The advertising media, which provides advertisements as described above, to which the present invention can be applied include TV commercials, home shopping programs, newspapers, magazines, radio programs, and Internet shopping sites. It is also apparent that entertainment contents, such as dramas and movies, can function as advertising media if they display access codes to enable the ordering, making a payment, and requesting detailed information on props or locations appearing in the content or on a product name appearing with particular information, for example, an analysis article on a particular product. Of course, although an access code may not be displayed for each and every point in time, the user may specify an information media carrying the advertisement of interest to be provided with the required data, as will be described hereinafter.

The user terminal can also be realized as a communication terminal capable of performing the above-mentioned functions, for example, a PDA, a cellular phone, or a remote control of an electronic device.

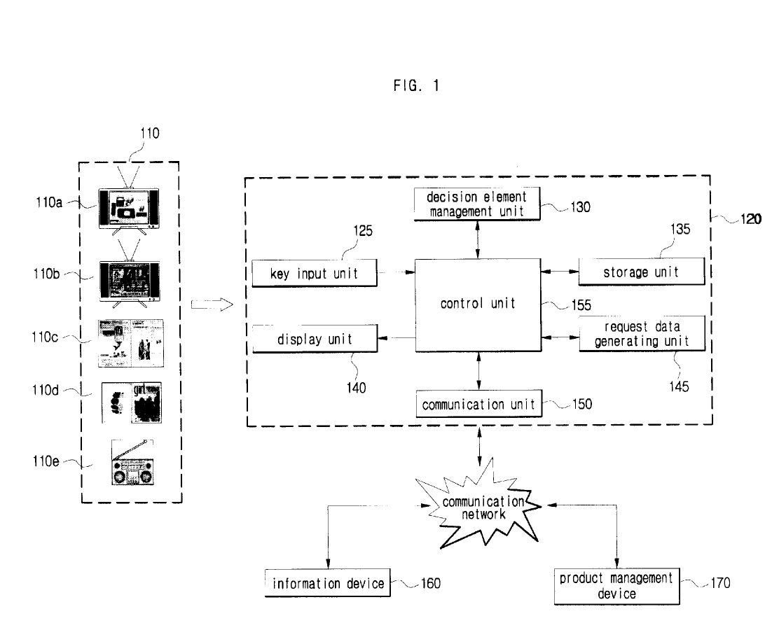

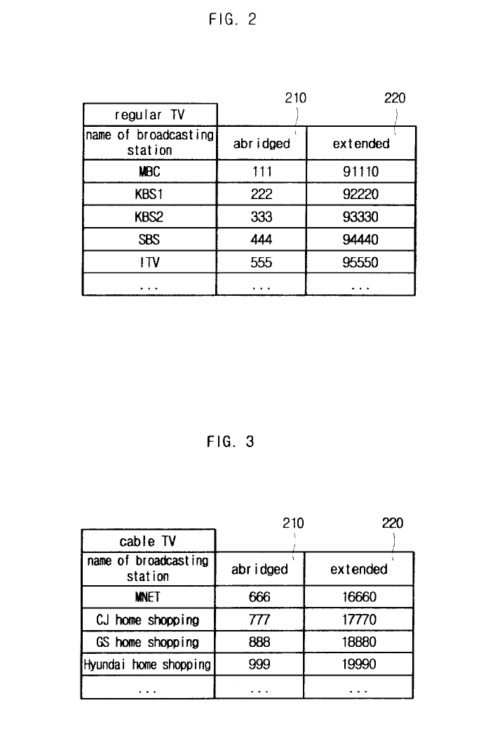

FIG. 1 shows an overview of a system for requesting service using access codes based on a preferred embodiment of the present invention, and FIGS. 2 to 4 illustrate forms of access codes based on a preferred embodiment of the invention.

As seen in FIG. 1, the user terminal 120 based on the present invention receives from the user an access code recognized over advertising media 110 (i.e. an example of information media) as input, and transmits the access code together with the time data to an information device 160 or a product management device 170, to execute the ordering and/or payment of the corresponding product or to receive detailed information corresponding to the product of interest and display it on a display unit 140. Of course, the information device 160 and the product management device 170 may be integrated as a single device.

The advertising media 110 includes media by which the advertisements and access codes are recognized visually, such as television 110a, 110b, newspapers 110c, magazines 110d, and Internet websites (e.g. Internet shopping malls), etc., and media by which the advertisements and access codes are recognized auditorily, such as radio 110e, etc. In general, television advertisements include TV commercials 110a, provided in a short time duration between broadcast programs, and home shopping programs 110b, provided in a specified time limit via a home shopping channel to encourage the sale of one or more products. In addition, if access codes may be displayed to provide detailed information and enable ordering/payment, etc. on filming locations and props worn by the characters in broadcasted programs (e.g. TV series) or movies played via DVD's, etc., it is apparent that this may also be regarded as advertising media. Newspapers 110c and magazines 110d carry advertisements on one or more pages or in particular areas within a page. Of course, if access codes may be printed and displayed to provide detailed information and enable ordering/payment, etc. in particular words (e.g. “MP3 player from iRiver”, etc.) within an area that is not designated an advertisement area as described above (e.g. a newspaper article, etc.), it is apparent that this may also be regarded as advertising media.

As an application of the invention, access codes are displayed together in certain areas of advertisements outputted/displayed through the advertising media 110. FIGS. 2 to 4 illustrate forms of access codes based on a preferred embodiment of the invention.

As illustrated in FIG. 2 and FIG. 3, in the case of advertising media using television, the access codes may be composed in the form of an abridged access code 210, comprising only a channel ID code which differentiates the broadcasting station only (e.g. 111 for MBC), or an extended access code 220, comprising a media ID code (e.g. 9 for an air-wave broadcast), a channel ID code (e.g. 111 for MBC), and a serial number (e.g. 0), etc. The codes may also be composed of just the channel ID code (e.g. 111 for MBC), and the serial number (e.g. 0). The serial number may be utilized when specifying a product from among various products (e.g. package products, selected options, etc.) displayed through the advertising media. For example, in a TV series picture, the serial number may be further categorized, with the serial number for the car that the main male character is driving assigned ‘0,’ and the top garment of the male character's wardrobe assigned ‘1.’ Also, the serial number may be divided to ‘0’ for ordering/payment, and ‘1’ for requesting detailed information, which may be added as a separate ID code. The media ID code, channel ID code, and serial number may each be configured to have the necessary number of digits, and may each be separated by a separator (e.g. ‘−’ etc.). The access code may also be composed of a number sequence, a letter sequence, or an alphanumeric combination. Further, a default value may automatically be applied to the media ID code, because, for instance, it may be unnecessary for a user who purchases products only over air-wave broadcasts to input a media ID code every time a product is purchased. If a default value is to be applied for the media ID code, the media ID code may be automatically inserted into a resource storage structure within a storage unit 135, or the media ID code may be automatically applied in the decision element data during the transmission of a request data without storing the media ID code in the resource storage structure.

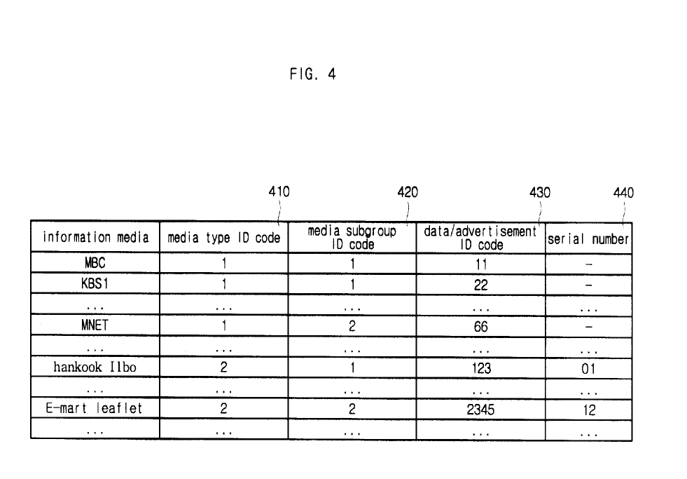

In addition, an access code may be composed of a media type ID code 410, media subgroup ID code 420, data/advertisement ID code 430 (hereinafter referred to as “content ID code”), and serial number 440, as illustrated in FIG. 4.

The media type ID code 410 may be an ID code for determining whether the advertising media 110 is visual media, print media, or sound media. For example, the code may be divided to ‘0’ for visual media, ‘1’ for print media, and ‘2’ for sound media.

The media subgroup ID code 420 may be an ID code for determining the characteristics of the advertising media 110. For example, the code may be divided to ‘1’ for air-wave broadcasts, and ‘2’ for cable broadcasts, etc., from among visual media. The code may be divided to ‘1’ for periodicals (e.g. newspapers, magazines, etc.), ‘2’ for non-periodicals (e.g. advertisement leaflets), and ‘3’ for individually published books, etc., from among print media. The code may be divided to ‘1’ for FM radio broadcasts, and ‘2’ for AM radio broadcasts, etc., from among sound media.

The media ID codes described above (i.e. the media type ID code 410 and the media subgroup ID code 420) may be integrated as one. For example, the media ID code may be assigned to be ‘0’ for air-wave broadcasts, ‘1’ for cable broadcasts, ‘2’ for satellite TV, ‘3’ for satellite DMB, ‘4’ for ground-wave DMB, ‘5’ for Internet displays, ‘6’ for periodicals, ‘7’ for non-periodicals (e.g. books, VOD, video content, and printed content, etc.), ‘8’ for AM radio, and ‘9’ for FM radio, etc.

The media ID code may be displayed on the screen or pages of each information media. For example, the media ID code may be displayed on the upper right corner of visual media together with the logo of each broadcasting station, and may be printed together on one side of a brand name, picture, or image displayed on print media.

Also, by using the media ID code described above, data may be calculated with regard to data access characteristics and statistics information for each form of information media.

The content ID code 430 may be an ID code for specifying the broadcasting station (or channel), newspaper publisher, or magazine publisher, etc., and the serial number may be an ID code for specifying the article number or product number, etc. The serial number may be substituted by, for instance, a product code.

As described above, the access codes may be provided with different lengths depending on the type or issuance period of the information media. For example in the case of visual media, relatively shorter access codes may be used as compared to those of print media. Also, the access codes may be shorter for media that is used regularly and frequently, for instance to improve convenience and efficiency in its usage, and relatively longer access codes may be used for media used irregularly and less frequently.

Also, in the case of sound media, the media ID code, which represents whether the broadcast is an AM radio broadcast or an FM broadcast, and the frequency value by which the broadcast is outputted may be used as access codes, as mentioned above.

The access code may be composed in various other ways besides the above, as long as the content (i.e. data, advertisement, etc.) provided over a particular information media can be specified. For example, ID codes corresponding to a language ID code, denoting the language in which the service is desired, and a region ID code, etc. may further be contained in the access code.

Allowing the user to select the desired language is convenient in that the detailed information or the ordering/payment may be provided in the selected language. Thus, a user may, while watching CNN, request detailed information corresponding to a news article (e.g. translations, related articles, etc.) and set the language ID code to Korean (for instance, ‘0’) to be provided the information in Korean. If the user does not input a language ID code corresponding to a selected language, the service may be provided in a language set as the default in the user terminal 120.

Also, a region ID code may be included to allow the user to request detailed information, ordering/payment on accurate data or advertisements. This is because the same broadcast channel may provide during the same time period different programs or advertisements for each region. If the user does not input a region ID code, location data recognized through GPS satellite signals, communication station signals, etc., may automatically be converted to a corresponding region ID code pre-stored in the storage unit 135, to be included in the request data and transmitted to the information device 160, etc. For example, the region ID code may be an ID code corresponding to region data configured by the user using a set region function of the terminal. In other words, the user may configure the setting to a particular region using a set region function, etc. This is because in the case of broadcasts in general, the coverage may be different according to the transmission media. For instance, while a satellite broadcast covers a whole country, an air-wave broadcast may provide different broadcast content for each regional area within the reach of the air-waves, and a cable television (CATV) broadcast may provide different broadcast content for each county or district. Consequently, in the U.S., Europe, and China, where a country covers a vastly wide area, the same broadcast channel may be distributed to different broadcast businesses for each region. Of course, location data such as OPS satellite signals, etc. may be converted by the information device 160 and/or product management device 170 to region ID codes or location codes, etc. Thus, by the use of the region ID code, cases with identical media ID codes and content ID codes may be recognized to be related to different businesses. It is apparent that by including a region ID code in the access code, a user may also be provided location-based services of a particular region (e.g. a search on stores in which the service or product purchase corresponding to the access code is possible).

Further, the access code may be composed to contain a service number. A service number is for specifying the service desired by a user, with, for example, ‘7’ set to mean a phone connection to an operator, and ‘9’ set to mean ARS ordering. Distinguishing whether or not an inputted data is a service number can be made possible by using the number of digits of the access code or by using predetermined separators (e.g. *, #, etc.). If a common service number applies to all advertisers, etc., the user may be provided a desired service selectively without a separate service number supplied via the advertising media 110, etc.

With reference to FIG. 1, the user terminal 120 based on the present invention comprises a key input unit 125, a decision element management unit 130, a storage unit 135, a display unit 140, a request data generating unit 145, a communication unit 150, and a control unit 155. It is apparent that certain components (e.g. the decision element management unit 130, the request data generating unit 145, etc.) of the user terminal 120 illustrated in FIG. 1 may be implemented in the form of a software program.

The key input unit 125 is a means to input an access code or a command to generate an access code, input a command to store an access code, search and select a stored access code, and input a command to generate a request data, etc. The key input unit 125 may, for example, be realized in the form of a key pad having a plurality of keys or a touchpad, etc.

The user may use a variety of message transmission methods (e.g. SMS, instant messenger, multimedia messages, and e-mail, etc.) to transmit to another receiver a stored access code and a corresponding time data generated using the key input unit 125, and the receiver may use the data to order the corresponding product or to request detailed information on the product. In this manner, a user can recommend a desired or purchased product to a third party. Of course, recommending an order or detailed information for a certain product by transmitting the access code and the corresponding time data to another receiver is not limited to the communication functions between each user, and it is apparent that the case may be extended to certain advertisers (e.g. news agencies, broadcasters, and content providers, etc.) sending advertisement messages to members and non-members. However, if a consumer has generated a connection data file including payment data for exclusive use by the consumer, the connection data file itself cannot be transmitted to another receiver, in which case the order payment terminal 120 may further comprise a file modification function to remove the payment data from the connection data file. Of course, it is apparent that the consumer could send a connection data file including payment data to another receiver as a present, where the receiver would settle the purchasing cost using the payment data of the consumer and have the purchased product sent to a desired place of delivery. Here, to minimize unforeseen loss due to the connection data file, the consumer could include option data in the connection data file (see 009 of Table 1). The option data may contain limits on the time period and number of orders, etc. for which the connection data file may be in effect.

In addition, if a user plans to order the product corresponding to an access code at a later time, the user may use a pre-configured memo function to input related information as to what product the access code represents and what its features are, using the key input unit 125.

The decision element management unit 130 manages decision element data stored in the storage unit 135. The decision element data is for specifying the content (i.e. data or advertisement) corresponding to a detailed information request or ordering/payment, and may contain the access code and time data. Also, when a message including an access code and time data is received from another sender, the decision element management unit 130 may interpret the message to extract the decision element data, and store the decision element data in the storage unit 135.

The storage unit 135 may store an operating system of the user terminal 120, access codes, time data related to the input or generation times of such access codes (e.g. in the form of year/month/day-hour/minute/second: YMD-HMS), payment data, hobbies, personal data, and terminal access data, etc. The decision element data stored in the storage unit 135 may be generated by a user's command or may be extracted after a message received from another sender is interpreted by the decision element management unit 130. The decision element data may be converted (i.e. into a form of a save file) to a file format (e.g. *.tml (text meta link), *.iml (image meta link), etc), wherein the access code and time data are integrated, and stored in the storage unit 135. The name of the converted save file may automatically be generated according to a pre-configured set of rules as a combination of the access code and time data (for example, access code+time data). If the decision element data is stored in the form of a save file, additional benefits may be expected of convenience in transmitting the decision element data to another receiver, etc.

TABLE 1

| Resource Storage | |
|---|---|
| Structure No. | Records of N fields |
| 001 | conversion data, time data |
| 002 | conversion data, time data, location data |
| 003 | conversion data, time data, personal data |
| | (e.g. preferences code) |
| 004 | conversion data, time data, personal data |
| | (e.g. membership data) |
| 005 | conversion data, time data, terminal access data |
| 006 | conversion data, time data, terminal access data, |
| | e-mail address |
| 007 | conversion data, time data, terminal access data, |
| | payment data |
| 008 | conversion data, time data, gender |
| 009 | conversion data, time data, payment data, option |
| | data (time limit, number of orders limit, etc.) |
| . . . | . . . |
| 999 | conversion data, time data, terminal access data, |
| | hobby, e-mail address, payment data |

As described above, by varying the resource storage structure, decision element data from identical access codes and identical time data may provide different detailed information or order products for each user. For example, by choosing the resource storage structure as 008, for a product advertised on the same channel at the same time, the ordering or providing detailed information may be tailored according to gender.

A default type may be applied for a resource storage structure described above, or a user may select a type when storing each decision element data. For example, if a user plans to place an order in the future using a recently generated decision element data and desires the ordering and payment to be completed in one process without supplying additional payment data, the user may select resource storage structure 007 for the decision element data, so that additional payment data will not be necessary when the product is ordered later.

Of course, in selecting the resource storage structure, the user may use an option select screen displayed on the display unit 140 to individually select each additional data (e.g. terminal access data, payment data, etc.) besides the necessary data (i.e. access code and time data). The resource storage structure number or options, etc. may be selected, for instance, through a separate function menu displayed on the user's screen.

The save files generated by the various resource storage structures described above may each be stored in independent directories automatically, or in directories specified by the user.

Similar to the conventional speed dial feature, which allows a stored telephone number to be selected promptly, the decision element data and/or save files stored in the storage unit 135 may be selected promptly using certain speed codes.

In addition, the name of a connection save file generated by a method described above may be generated automatically according to a pre-configured generation method. For example, the name may be generated as a combination of the media ID code and the generation time. Another example may contain the name of a broadcaster and the title of a broadcast program, for easy searches by the user in future usage. If the name of the broadcaster and the title of the broadcast program of the time in question corresponding to the conversion data are already stored in the storage unit 135 of the user terminal 120, the decision element management unit 130 may extract the required information to automatically generate a name for the connection data file. In this case, the file format stored in the storage unit 135 may be a temporary file or a permanent save file. However, if the name of the broadcaster or the title of the broadcast program corresponding to the conversion data is not already stored, the conversion data and time data may be transmitted to the information device 160 and/or product management device 170 via a communication network to receive the information necessary in automatically generating a name of the connection data file. Of course, a temporary name for the connection data file may be generated and stored, which would be renamed later after receiving the necessary information from the information device 160 and/or product management device 170.

By storing the decision element data in the storage unit 135, the user does not need to make a purchasing decision immediately during a real-time advertisement broadcast (e.g. commercials between programs, home shopping broadcasts, TV series, movies, etc.), and instead may order and/or request detailed information for a product broadcasted in the past using the stored decision element data. Here, information that represents what product the access code refers to may need to be stored (i.e. using the memo function) additionally. Further, the storage unit 135 may record the broadcast display or the sound data, when the user terminal 120 is a terminal that can receive broadcasts, such as DMB phones and terminals with built-in radio, etc., in which case the time data representing the time of recording is stored together. Of course, the time data may also be recognized as the user manually inputs the time stamp contained in recorded contents (e.g. recorded images on video tapes, etc. and recorded images in electronic files).

Moreover, the storage unit 135 may, as described above, further store additional data according to the type of user terminal 120. For example, when the user terminal 120 is a cell phone, communication function data (e.g. device ID number, phone number, etc.) may further be stored. As mentioned above, if the stored data can identify the consumer and can function as data used for payment, the user can settle a payment for a product purchase simply by transmitting the data to the product management device 170, without having to become a member or having to provide a credit card number, etc. Thus, with the present invention, it is convenient for a user to be provided a service or to make an order and payment when using a shopping mall, even when the user has not signed up as a member for a particular service.

Also, to ease the process for a user to request an order for a product or request detailed information, the storage unit 135 may further store connection data template files corresponding to each advertising media. The connection data template file may be an electronic file (e.g. a file with an *.lit (Link Information Template) extension) generated with just the time data omitted, and the name of the template file may be generated to display the broadcaster, etc. The connection data template file may be pre-generated to correspond to major broadcasters and shopping malls, etc., and may be provided from the broadcasters, shopping malls, or a template file provider, while the template files may be stored collectively in a predesignated directory. For example, if a user desires to purchase a product broadcasted on the Hyundai home shopping channel at ten minutes after ten, the user may select the template file corresponding to the Hyundai home shopping broadcasting station from the related directory and input a command to generate a connection data file, at which point the time data will automatically be included to generate a connection data file. In this case, the name of the connection data file may contain at least one of the title of the program corresponding to the time and the name of the product, etc. The program title, etc. for generating the name of a connection data file may be data pre-stored in the storage unit 135 or data provided from another provider device (e.g. the information device 160, product management device 170, etc.).

The display unit 140 displays a detailed information screen, corresponding to the operational status of the user terminal 120, and data (e.g. web data, connection URL, etc.) received from the information device 160 via the communication unit 150 in response to request data, and/or an order and payment screen, corresponding to data (e.g. web data, connection URL, etc.) received from the product management device 170, etc. Also, access codes, etc. stored in the storage unit 135 are displayed in the form of line listings, etc. awaiting the user's selection.

The request data generating unit 145 generates request data using the access code and the time data for the time the access code is inputted/generated by the control of the control unit 155. The request data may be an order information or a detailed information request. The request data may be generated to correspond to the usage ID code contained in the access code, or may be generated to correspond to a control command (e.g. an order request or a detailed information request) inputted via the key input unit 125. As described above, the request data generating unit 145 may include location data (e.g. region code, etc.), corresponding to the current location of the user terminal 120, in the request data. This is to prevent malfunctioning or wrong orders in the case of advertisements aired only in local broadcasts. For example, the region code may be made to automatically correspond to the current position of the user terminal 120. Further, by use of the region code, etc., identical channel ID codes may be recognized as different businesses if the regions are different.

The communication unit 150 converts the request data generated by the request data generating unit 145 to data of a pre-configured format for transmission over a communication network, and transmits the data to the information device 160 and/or product management device 170. It also receives certain data or connection addresses from the information device 160 and/or product management device 170.

The control unit 155 controls the key input unit 125, decision element management unit 130, storage unit 135, display unit 140, request data generating unit 145, and communication unit 150 so that the user terminal 120 based on the present invention performs the functions described above.

Although it is not illustrated in FIG. 1, the user terminal 120 may further comprise an access code interpreter unit (or a connection data extraction unit). The access code interpreter unit interprets the access code inputted by a user to determine what kind of data the access code is requesting (e.g. detailed information, product ordering, etc.) using a mapping table (this may be stored in the storage unit and may contain connection data to certain destinations), before the code is processed. For data interpretable by the access code interpreter unit, a direct request is possible from the user terminal 120 to the destination without transmitting the request data to the information device 160, etc. In other words, some or all of the functions performed by the information device 160, such as extracting the connection address for detailed information, etc., are performed at the user terminal 120. Using telephone numbers as an example, if the request is for service corresponding to emergency numbers (e.g. 114, 119, 123, 128), daily assistance numbers, or numbers for emergency rooms in hospitals, traffic and tourism guides, journalists, banks, insurance companies, or stockbrokers, etc., and the related access codes are already stored in a mapping table, the user terminal 120 interprets the destination directly and processes the request without the aid of the information device 160. The user terminal 120 may comprise a conversion data interpreter unit to perform services such as basic channel connections, and reserved words, etc. Embodiments using reserved words will be explained separately in the related section.

The information device 160 searches and extracts detailed information corresponding to the request data received from the user terminal 120 and transmits it to the user terminal 120. To search and extract the detailed information, the information device 160 may extract the access code and time data contained in the request data, compare them to a pre-stored mapping table, and extract the data for the corresponding detailed information or the connection address to the detailed information. For example, if the advertising media 110 is television, the information device 160 may compose and pre-store the broadcasting program lineup for each data and time in the form of a mapping table to provide detailed information on the programs and advertisements, etc. outputted on television.

The data transmitted by the information device 160 to the user terminal 120 may be an option screen including a plurality of options corresponding to the request data, and in the option screen may be included options corresponding to service categories (e.g. detailed information request, ordering/payment, etc.) related to the transferred data (e.g. broadcasting program data, advertisement, etc.) before or after the time data contained in the request data.

The product management device 170 searches and extracts the detailed information or order corresponding to the request data received from the user terminal 120 and transmits it to the user terminal 120. The information device 160 may extract the access code and time data contained in the request data, compare them to a pre-stored mapping table, and extract the data for the corresponding detailed information or the connection address to the detailed information for the search and extraction of the detailed information, etc. For example, if the advertising media 110 is television, the information device 160 may compose and pre-store the broadcasting program lineup for each data and time in the form of a mapping table to provide detailed information on the programs and advertisements, etc. outputted on television.

The data transmitted by the product management device 170 to the user terminal 120 may be an option screen including a plurality of options corresponding to the request data, and in the option screen may be included options corresponding to service categories (e.g. detailed information request, ordering/payment, etc.) related to the transferred data (e.g. broadcasting program data, advertisement, etc.) before or after the time data contained in the request data.

Also, the product management device 170 may receive payment data (e.g. cell phone number, vehicle license number, credit card number, ID, password, certification data, etc.) from the user terminal 120 and make a payment on a product corresponding to the request data. That is, the product management device 170 transmits to a user terminal 120 a payment request corresponding to a product for which an order request has been received from the user terminal 120, and uses the payment data (e.g. credit card number, telephone number, certification data, etc.) received from the user terminal 120 to make a payment. In this case, the product management device 170 may transmit parameter request values, which are necessary to provide a service such as making a payment, etc., to the user terminal 120 via the payment request, where the parameter request values may be for requesting, for instance, a cell phone number and various certifications, etc.

Also, the parameter request values may further contain a request for information necessary for the user to sign up as a member. The parameter values corresponding to the parameter request values received from the product management device 170 may be extracted by the user terminal 120 from personal data pre-stored in the storage unit 135 of the user terminal 120, or the data may be inputted by the consumer via the key input unit 125, before they are transmitted.

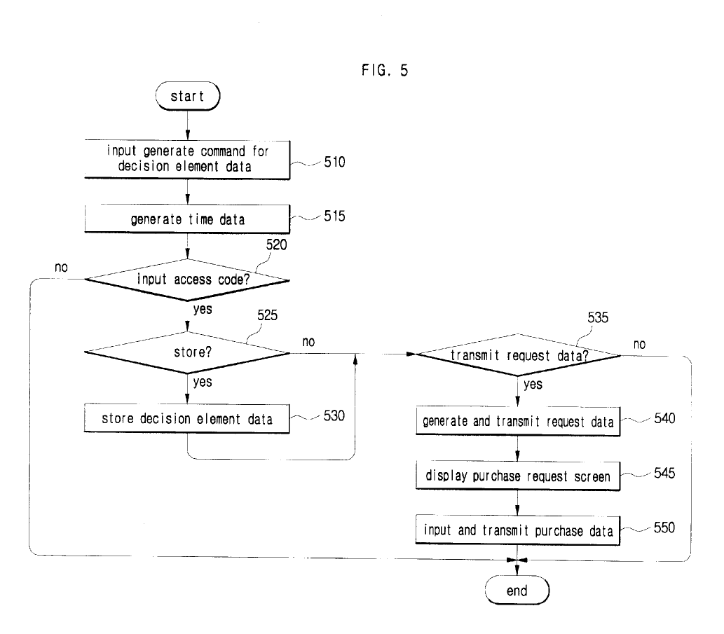

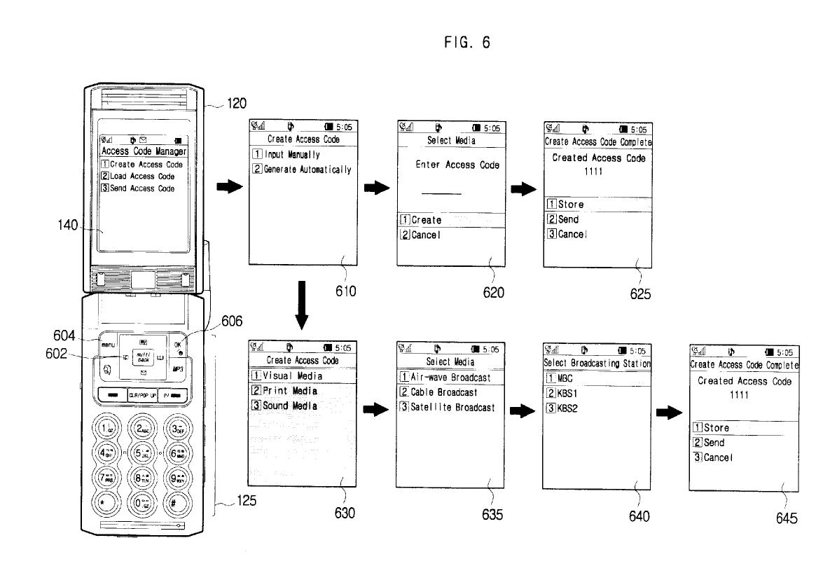

FIG. 5 is a flowchart illustrating a method for requesting service using access codes based on a preferred embodiment of the invention, and FIG. 6 shows an example of a user interface (UI) screen illustrating the process by which access codes are inputted to request service, based on a preferred embodiment of the invention.

A decision element data based on the present invention comprises an access code and a time data. The time data may be the time that the access code is inputted or a time specified in advance for inputting the access code. With the former, the user inputs the access code and presses a pre-configured button that enables the inputted data to function as the access code (e.g. a save button or a transmit button), at which point the current time is generated into the time data. Therefore, the latter may be a more preferable method. This is because for a user unfamiliar with the input of access codes, the data output may end and another output start while the access code is being inputted. Therefore, hereinafter the descriptions will focus on the latter case of inputting the access code after specifying the time in advance.

With reference to FIG. 5, the user terminal 120 receives a command to generate decision element data as input from the user in step 510. A software program for generating and managing decision element data may be installed in the user terminal 120.

In step 515, the user terminal 120 generates and stores the time data at which the command to generate decision element data was inputted in step 510. If the information media is television, for instance, the time that the data or advertisement was outputted may be recognized using the time data. The time data may be composed in the form of year/month/day-hour/minute/second (YMD-HMS), or may be composed with only a portion, such as hour/minute (MS), for convenience. Of course, the time data may be inputted by the user, instead of being automatically generated. For example, if detailed information is needed on a data found in an article of a newspaper dated a few days before, the user may check the date of the newspaper of interest and input the data as the time data.

Also, the user terminal 120 may also perform a compensation function for the time data at which a command is inputted to generate a decision element data. Satellite broadcasts and Internet broadcasts, etc. may be displayed with a time discrepancy (1-3 seconds, for example) between multiple viewers, due to inconsistencies in transmission speed and network difficulties, etc. In some cases, time discrepancies may occur even with the same air-wave broadcasts.

In such a case, a discrepancy may occur between the time of a broadcast program lineup managed by the system and the time data generated at a user terminal 120. For example, supposing an electronic dictionary commercial is scheduled to be aired between 9 h 10 m 05 s and 9 h 10 m 35 s p.m. in the broadcast program lineup, if a user were to view the electronic dictionary commercial at a relatively later time due to the time discrepancy between 9 h 10 m 08 s and 9 h 10 m 38 s p.m., and then transmit a purchase request, containing the time data at which the command to generate a decision element data was inputted, to the product management device 170 at 9 h 10 m 37 s, the product management device 170 would be unable to recognize the product corresponding to the time or would recognize the entry as another product, due to the time discrepancy.

To solve the foregoing problem, the user terminal 120 based on the present invention may be configured to make the saved time data slightly earlier than the actual saved time. This is based on the fact that a consumer would seldom generate the acquire data at the immediate start of a product advertisement, and in a majority of cases would generate the acquire data at a relatively later time, such as near the end of the product advertisement.

Further, if an array representing the media ID code is contained in the access code, the user terminal 120 may compensate the pre-stored time data by a time amount corresponding to the time discrepancy of the advertising media corresponding to the media ID code. The time data compensation described above may be performed by the control unit 155.

In step 520, the user terminal 120 determines whether or not an access code is inputted by the user using the key input unit 125. The access code may be a number sequence, letter sequence or an alphanumeric combination displayed to correspond to the data or advertisement provided over the information media. As explained above, in the case of sound media, the access code may be the frequency value (for instance, 939 for 93.9 MHz, where code values to differentiate FM radio broadcasts and AM radio broadcasts may further be included) by which the broadcast is outputted. Also, when the telephone number of the receiver is known, the telephone number itself may be used as the access code. Moreover, in the case of television broadcasts (e.g. broadcast programs, home shopping, etc.), the broadcast channel (i.e. the channel ID code) may be used as an access code by itself. The foregoing descriptions have also already explained that the access code may be implemented in various forms by optionally selecting the media ID code, serial number, content ID code, and language ID code, etc. The information device 160, etc. may extract web data or connection addresses corresponding to the service requested by the user using the access code and time data and send them to the user terminal 120.

If it is determined in step 520 that an access code has been inputted, the process continues to step 525, wherein the user terminal 120 determines whether or not a store command has been inputted by the user.

If a store command has been inputted, the process continues to step 530, wherein the generated decision element data (i.e. access code and time data) is stored in the storage unit 135. In storing the decision element data, the user terminal 120 may convert the data to a data of a predetermined format. By displaying the decision element data stored in the storage unit 135 in the form of line listings, etc., a user may select the data at a later time.

If a store command has not been inputted, the process continues to step 535 to determine whether or not a transmit command for the request data has been inputted. If the transmit command for request data has been inputted, the process continues to step 540, wherein the request data is generated using decision element data, after which the generated request data is transmitted via a communication network to the information device 160 or the product management device 170. The transmission path of the request data may be controlled by the control unit 155 according to the type of access code or according to the user's control commands. Also, to make a payment concurrently with placing a product order, payment data (e.g. credit card number, telephone number, certification data, etc.) may additionally be included in the request data. In addition, if the advertisements may be different for each region, location data, etc. may additionally be included. Although storing decision element data or transmitting request data has been illustrated as selection steps in FIG. 5, the user terminal 120 may be pre-configured to automatically store the decision element data corresponding to the transmitted request data when a transmit command for the request data has been inputted in step 535 without a store command inputted in step 525. Of course, it is apparent that an auto save function may be omitted according to the user's configuration.

In step 545, the user terminal 120 displays information corresponding to the data or connection URL received from the information device 160 or the product management device 170 on the display unit 140. The information display screen shown on the display unit 140 may be a detailed information display screen or a purchase request screen. If payment data is contained in the request data, as described above, a purchase confirmation screen may be displayed in step 545. Also, the screen displayed in step 545 may be an option screen merely showing various data categories, awaiting the user's selection. For example, menus related to detailed information, ordering/payment, SMS, e-mail, speaking to an operator, and call back, etc., may be displayed on the display unit 140, allowing the user to select the optional services. In another example, when providing music service, menus related to album information, singer information, music videos, song lists, lyrics, ordering bell tunes, and color-ring service, etc., may be provided, awaiting the user's selection. Also, for the case of multiple data and/or advertised products outputted at the same time, a list (or search information, etc.) of the data and/or products may be transmitted to the user terminal 120 for the user's selection. Thus, the product management device 170, etc. may first recognize the data and/or product, determine whether the request is for ordering a product or for detailed information, and then perform the corresponding operations. Further, the information displayed on the display unit 140 in step 545 may provide not only the detailed information and ordering/payment screen data exactly matching the time data, but also provide the service content (e.g. detailed information request, ordering/payment request) before and after the time data as well in the form of an option list.

If the information display screen shown in step 545 is a purchase request screen, the user terminal 120 receives payment data corresponding to the purchase request screen as input from the consumer and transmits it via a communication network to the product management device 170 in step 550. As described above, when the product management device 170 transmits parameter request values necessary to provide service such as making a payment, etc., via a payment request to the user terminal 120, the purchase data input procedure of step 550 may be omitted, if the user terminal 120 extracts the corresponding parameter values from the personal data pre-stored in the storage unit 135 and transmits the values.

The foregoing descriptions focused on using data or advertisements displayed on information media and corresponding access codes to request detailed information on the data or advertisement and request ordering/payment.

However, in another preferred embodiment of the invention, a method of making a payment using the user terminal 120 for a user to settle a charge on tangible/intangible services provided at an off-line store.

For example, a user may use particular services by setting numbers, such as 2424 (movers' service), 4989 (sale transactions), 5151 (gas station), 7575 (utility bills), etc., as reserved words for the particular services in the user terminal 120. In other words, the user may input a reserved word and transmit it with the current time data to a pre-designated payment system to make a payment for a provided service or a purchased product. Of course, detailed information may also be provided for the service or product. If the reserved words can be implemented in a manner similar to a telephone directory function, etc., the user may be provided search and directory services.

For example, when a user inputs the reserved word (5151) and payment request amount and transmits them as a request after fueling gas at a gas station, the user terminal 120 recognizes the current location data and transmits it together to a corresponding payment system. In this case, the consumer may store the vehicle license number in the user terminal 120 beforehand for use in making a payment. Here, the location data in the user terminal 120 may be a code value of the gas station inputted directly by the user. The payment system recognizes the gas station corresponding to the current location data received, and then executes operations that enable the payment request amount be transferred from the user to the gas station. Therefore, the user does not need to carry a credit card, etc. to settle a payment request amount, by which illegal reproduction of the credit card by a gas station employee may be prevented. Further, the gas station may also offer customer compensation programs on-line, such as mileage points, coupons, and special events, etc., regardless of the user's method of payment (e.g. account payment, cash payment by direct-deposit cards, and credit cards, etc.).

Likewise, the user may utilize reserved words in using terminal ID numbers (for instance, telephone numbers, etc.) and bank payment functions to pay utility bills or look up detailed information on the utility bills.

Also, the user may pre-configure the settings so that the reserved words cooperate with particular save files, as described above. That is, the user may pre-store certain reserved words to match their corresponding data (for instance, vehicle license number, and in cases where payment is necessary, payment data). However, the save files do not contain time data beforehand, since the current time data at which the reserved word is inputted and transmitted must be contained. For example, if a user has pre-stored, in the storage unit 135 of the user terminal 120, the reserved word 5151 to be matched with the vehicle license number, the user terminal 120 transmits the stored vehicle license number and current time data to the payment system when the user inputs and transmits 5151 after fueling at a gas station. Likewise, the gas station transmits the gas price data and the vehicle license number to the same payment system, after which the payment system determines whether or not the vehicle data match and transmits the detected gas price data to the user terminal 120, and then the user confirms the gas price data displayed on the display unit 140 and requests payment so that the payment data may be transmitted to the payment system. Of course, it is apparent that the user may configure the settings so that the payment data stored to correspond to the reserved word input is transmitted together to the payment system, so that the payment made be completed without any additional procedures.

Similarly, the user may set ‘1661 (fancy restaurant),’ ‘1313 (locksmith),’ etc. as reserved words to be provided location-based services (for instance, search restaurant, nearest locksmith, etc.) corresponding to the current location. Moreover, it is apparent that the user may set the region ID code for the region in which the location-based services are desired.

Of course, the same effects may be obtained using access codes as explained above with reference to the accompanying drawings, without using the reserved words described above. For example, when a gas station employee supplies a consumer, who has fueled gas worth a certain amount at the gas station, with an access code, showing a gas station code and/or the cost, etc., or when the access code is displayed on a display device positioned near the gas pump, the user may input and transmit the access code using a user terminal 120 to transmit payment request data. This is identical or similar in its composition and process excepting only the few differences in the access code displayed over the information media and its uses, so that it may readily be understood by those skilled in the art. Therefore, detailed explanations on this subject are omitted.

FIG. 6 provides an example of a user interface (UI) screen illustrating the input process of access codes for requesting service based on the present invention. FIG. 6 describes a case where a separate program for generating and managing decision element data is stored in a user terminal 120. In other words, a user may input or generate an access code after launching the software program. It has already been explained above that a user may select a pre-defined button after inputting an access code in the initial screen to make the inputted data function as an access code.

As illustrated in FIG. 6, a user may enter the access code manager mode by selecting a short-cut button 602 or selecting the menu button 604 and OK button 606 on the user terminal 120. An access code manager mode screen is illustrated on the display unit 140.

The user may enable the create access code screen on the display unit 140 by selecting the “1. Create Access Code” option in the access code manager mode screen. The screen 610 is an example of a create access code screen organized for a manual input of the access code or an automatic generation of the access code.

When the user enables the screen 610, a corresponding time data may automatically be generated and stored in the storage unit 135. Of course, an additional function option (e.g. Modify Time Data, etc.) may further be included that allows the user to input a certain time data without generating a default time data. The user may use this function option to request detailed information and ordering/payment for data obtained in past print media (e.g. a newspaper from three days ago, etc.) or recorded content storing recorded images.

When the user selects “1. Input Manually” from the displayed options of the screen 610, a screen 620 that allows access code input is shown on the display unit 140. The user may select the “1. Create” option after inputting an access code to generate the access code. Of course, the screen 620 may further comprise a “3. Store” option and a “4. Send” option to immediately store the inputted access code or transmit the access code to the information device 160, etc.

When the user selects the “1. Create” option after inputting an access code, screen 625 is displayed on the display unit 140 to allow confirmation of the generated access code. The user may select a function option to store the generated access code in the storage unit 135, transmit the access code over a communication network, or delete a generated access code.

The process of the access code being automatically generated without the user's manual input is illustrated in screen 630 to screen 645. That is, when the user selects “2. Generate Automatically” among the displayed options of screen 610, an option screen for specifying the type of information media is displayed as screen 630 on the display unit 140.

When the user selects an information media form from among the options displayed on screen 620, screens to further specify the information media are sequentially displayed on the display unit 140. For example, if the user selects “1. Visual Media” from the options displayed on screen 620, options to further specify the type of visual media are displayed on the display unit 140 as in screen 635. If, for instance, the user selects “1. Air-wave Broadcast,” broadcasting stations or channel information related to performing the air-wave broadcasts are displayed on the display unit 140. If the user selects a broadcasting station or channel information, a corresponding access code is automatically generated as in screen 645.

The user may store the generated access code for later use in requesting detailed information or ordering/payment, or may generate a request data containing the access code generated in real-time and transmit the data to the information device 160, etc.

When the request data containing the access code inputted/generated by the above process is transmitted to the information device 160 and/or product management device 170, the information device 160, etc. extracts the data or connection address corresponding to the request data and transmits it to the user terminal 120. A screen displayed on the user terminal 120 may comprise various similar options. For example, when a user generates and transmits a request data using an access code displayed on an advertisement screen outputted between programs, an information screen comprising options such as ‘detailed information on an advertised product,’ ‘request purchase of advertised product,’ ‘detailed information on background music,’ and ‘purchase background music,’ etc. may be displayed on the display unit 140 of the user terminal 120. Of course, it is apparent that a pre-determined access code corresponding to each option may be displayed together.

The drawings and detailed descriptions are for illustrative purposes only with regard the present invention. They are used merely to explain the invention, and do not limit the invention as set forth in the claims. Therefore, those skilled in the art will understand that many variations and other embodiments may be made without departing from the scope of the invention. The scope of the invention will thus be defined only by the sprit of the invention as set forth in the appended claims.

### INDUSTRIAL APPLICABILITY

As described above, a method and apparatus for requesting service using access codes based on the present invention allow easy access to detailed information on a data or an advertisement and/or easy ordering and payment for a product corresponding to the advertisement of interest using access codes assigned to the data or advertisement corresponding to the information media (e.g. visual media, print media, and sound media).

Also, the invention provides a method and apparatus for requesting service using access codes, in cases where the display of access codes may be difficult such as in visual media or sound media, wherein pre-designated access codes or frequencies are identified as the access codes corresponding to particular data or advertisements to provide the related services.

Further, the invention allow services using access codes to be provided regardless of the type or capabilities of the user terminals.

Also, the invention allows the data supplied over visual media or sound media or detailed information and/or ordering with regard to an advertisement to be provided in a non-real-time manner, thereby allowing the consumer to make a careful decision when ordering a product, and consequently discouraging impulse buying.

In addition, the invention provides a method and apparatus for requesting service using access codes, with which optimal service may be provided without language limitations even for a broadcast or website with a worldwide audience.

Also, the invention allows decision element data (e.g. data generated using the access code and time data, etc.) generated by a first user to be transmitted to a second user, so that the second user may access the same service.

Also, the invention enables a user to make a payment for a product order using a communication terminal.

Moreover, the invention allows payment for a product or service (e.g. gas, food, etc.) even at an off-line store (e.g. gas station, restaurant, etc.) using a reserved word.

Also, the invention allows accurate ordering of a product by automatically correcting a discrepancy occurred between the time the data is received and the time the data is displayed, which may exist even in satellite broadcasting or in the same broadcasting medium.

1. A method of requesting service using a user terminal related to transferred data corresponding to at least one of a data and an advertisement provided over information media, comprising:
(a) receiving an access code corresponding to the transferred data as input;
(b) generating a request data corresponding to at least one of an order request and a detailed information request using the access code and a corresponding time data when a transmission request for the request data is inputted, and transmitting the generated request data to a service apparatus including at least one of an information device and a product management device; and
(c) displaying information corresponding to data or connection address data received from the service apparatus;
wherein the information media is at least one of visual media, print media, and sound media, and the time data is configured to be the time before or after the input of the access code.

2. The method of claim 1, further comprising:
storing the access code and the time data;
displaying one or more access codes in response to a display stored data command; and
receiving as input a select command for the access code, and a generate and transmit command for the request data
before generating a request data (step b).

3. The method of claim 2, wherein the access code and the time data are stored as electronic files in a pre-configured file format when storing the access code and the time data.

4. The method of claim 3, wherein the electronic file is generated to comprise one or more additional data corresponding to a pre-configured or user-specified resource storage structure, said additional data including one or more of location data, personal data, payment data, access data of the user terminal, hobby data, gender data, e-mail address, and assigned service number data.

5. The method of claim 1, wherein the service apparatus extracts, from a pre-stored mapping table, data corresponding to the access code and the time data or connection address data and transmits the data to the user terminal.

6. The method of claim 1, wherein the time data is revised time data, in which the original time data configured to be the time before or after the input of the access code is compensated by a predetermined discrepancy value.

7. The method of claim 1, wherein in generating a request data (step b), the request data is generated using the location data, the access code, and the time data, after recognizing the location data of the user terminal.

8. The method of claim 1, further comprising:
receiving a payment data request corresponding to the order request from the service apparatus; and
transmitting payment data to the information device via a communication network in correspondence to the payment data request.

9. The method of claim 1, wherein the access code is data corresponding to any one of a frequency, by which the transferred data is outputted, and a telephone number corresponding to the transferred data, when the information media is sound media.

10. The method of claim 1, further comprising:
pre-storing connection data corresponding respectively to one or more access codes;
determining whether or not the inputted access code matches the stored access code; and
proceeding to generating a request data (step b) if the inputted access code does not match the stored access code.

11. The method of claim 10, further comprising:
extracting connection data corresponding to the access code if the inputted access code matches the stored access code; and
attempting a connection via a communication network using the extracted connection data.

12. The method of claim 1, wherein the access code is formed of any one of a number sequence, a letter sequence, and an alphanumeric combination.

13. The method of claim 12, wherein the access code comprises at least one of a media ID, a content ID, a serial number, and a product ID code.

14. The method of claim 13, wherein the access code further comprises at least one of a language ID code and a location ID code.

15. The method of claim 14, wherein the data displayed when displaying information (step c) is location-based data corresponding to the location ID, when the access code comprises the location ID code.

16. The method of claim 14, wherein the data displayed when displaying information (step c) is displayed in a language corresponding to the language ID, when the access code comprises the language ID code.

17. The method of claim 1, wherein the data displayed when displaying information (step c) is an option screen including a plurality of options corresponding to the request data.

18. The method of claim 17, wherein the option screen includes options corresponding to service categories corresponding to transferred data before or after the time data.

19. The method of claim 1, wherein the time data is inputted via an input unit, when the transferred data is video- or audio-recorded data.

20. The method of claim 1, wherein the length of the access code is variable depending on the characteristics of the information media, said characteristics including at least one of media type, issuance period, and frequency of usage.

21. A user terminal by which to request service related to transferred data corresponding to at least one of a data and an advertisement provided over information media, comprising:
an input unit, to which a command for transmitting access codes and request data is inputted;
a storage unit, storing the access code and a corresponding time data;
a request data generating unit, which generates request data corresponding to at least one of an order request and a detailed information request using the access code and the corresponding time data when the transmit command of the request data is inputted;
a communication unit, which transmits the generated request data to a service apparatus including at least one of an information device and a product management device, and receives corresponding data or connection address data from the service apparatus; and
a display unit, which displays data corresponding to the received data or the connection address data;
wherein the information media is at least one of visual media, print media, and sound media, and the time data is configured to be the time before or after the input of the access code.

22. The user terminal of claim 21, wherein the storage unit stores electronic files generated to correspond to the access code and the time data, when the user terminal further comprises a file generating unit which generates electronic files in a pre-configured file format using the access code and the time data.

23. The user terminal of claim 22, wherein the file generating unit generates the electronic file to comprise one or more additional data corresponding to a pre-configured or user-specified resource storage structure, said additional data including one or more of location data, personal data, payment data, access data of the user terminal, hobby data, gender data, e-mail address, and assigned service number data.

24. The user terminal of claim 21, further comprising a connection data extraction unit which extracts the stored connection data in correspondence to the access code inputted through the input unit, when the storage unit pre-stores connection data corresponding to one or more access codes

25. The user terminal of claim 21, wherein the communication unit transmits the access data and a corresponding time data in correspondence to a receiver data when a selection command for the access code and the receiver data are inputted through the input unit.

26. The user terminal of claim 21, further comprising a time correction unit, which generates revised time data by compensating the original time data, which is configured to be the time before or after the input of the access code, by a predetermined discrepancy value.

27. The user terminal of claim 21, further comprising a location data generating unit, which generates the location data of the user terminal, wherein the request data generating unit generates the request data using the generated location data, the access code, and the time data.

28. The user terminal of claim 21, further comprising a payment data extraction unit, which extracts the payment data and provides it to the service apparatus via the communication unit, when the storage unit further stores payment data, and the communication unit receives a payment data request from the service apparatus corresponding to the order request.

29. The user terminal of claim 21, wherein the access code is data corresponding to any one of a frequency, by which the transferred data is outputted, and a telephone number corresponding to the transferred data, when the information media is sound media.

30. The user terminal of claim 21, wherein the access code is formed of any one of a number sequence, a letter sequence, and an alphanumeric combination comprising at least one of a media ID, a content ID, a serial number, and a product ID code.

31. The user terminal of claim 30, wherein the access code further comprises at least one of a language ID code and a location ID code.

32. The user terminal of claim 31, wherein the data displayed via the display unit is location-based data corresponding to the location ID, when the access code comprises the location ID code.

33. The user terminal of claim 31, wherein the data displayed via the display unit is displayed in a language corresponding to the language ID, when the access code comprises the language ID code.

34. The user terminal of claim 21, wherein the data displayed via the display unit is an option screen including a plurality of options corresponding to the request data.

35. The user terminal of claim 21, wherein the length of the access code is variable depending on the characteristics of the information media, said characteristics including at least one of media type, issuance period, and frequency of usage.

36. A recorded medium readable by a digital processing device, tangibly embodying a program of instructions executable by the digital processing device to perform a method of requesting service using access codes, said method comprising:
receiving an access code corresponding to a transferred data as input;
generating a request data corresponding to at least one of an order request and a detailed information request using the access code and a corresponding time data when a transmission request for request data is inputted, and transmitting the generated request data to a service apparatus including at least one of an information device and a product management device; and
displaying information corresponding to data or connection address data received from the service apparatus;
wherein the information media is at least one of visual media, print media, and sound media, and the time data is configured to be the time before or after the input of the access code.
